(19) United States
(12) Patent Application Publication
(10) Pub. No.: US 2026/0259034 A1
(43) Pub. Date: Sep. 3, 2026

(54) RETRACTABLE WALL BOARD SENSOR SYSTEMS

(71) Applicant: Georgia-Pacific Gypsum LLC, Atlanta, GA (US)

(72) Inventors: Matthew E. Arinez, Kennesaw, GA (US); Greg Cushman, Atlanta, GA (US); Lance Mortimer, Atlanta, GA (US)

(21) Appl. No.: 19/165,153

(22) PCT Filed: Apr. 11, 2024
(86) PCT No.: PCT/IB2024/053535

§ 371 Date: Sep. 15, 2025

Related U.S. Application Data
(60) Provisional application No. 63/468,552, filed on May 24, 2023.

(51) Int. Cl. G01B 11/06; G01B 11/02; G01B 11/26

(52) U.S. Cl. CPC G01B 11/06; G01B 11/028; G01B 11/26

(57) ABSTRACT

Methods, apparatuses, systems, computing devices, and/or the like are provided for a sensor system. According to various embodiments, an example sensor system includes a frame; a plurality of rails configured to be supported by the frame and removably attached to the frame; a plurality of sensors fixedly attached to the plurality of rails, wherein the plurality of sensors are configured to detect a position, thickness, length, or orientation of one or more wall boards disposed on or within the frame and to send one or more signals based on the position, thickness, length, or orientation of the one or more wall boards; and a controller in networked communication with the plurality of sensors and configured to receive and transmit the one or more signals received from the plurality of sensors.

### RELATED APPLICATION

This application claims priority to U.S. Provisional Application No. 63/468,552, filed on May 24, 2023, which is incorporated by reference herein in its entirety.

### TECHNICAL FIELD

The present disclosure relates generally to materials manufacturing. In particular, this disclosure relates to detecting the position and thickness of wall boards on a conveyor, as well as to detecting the presence of overlapped boards and providing feedback to prevent inefficiencies.

### BACKGROUND

During wall board production, boards may be stacked within a multilayered structure prior to entering a dryer or other step in the production process. Efficiency and economies of scale may be achieved by increasing the number of wall boards stacked within the structure. To maximize efficiency, the space between the stacked wall boards in the multilayered structure may be reduced to enable more wall boards to be stacked within the structure. Sensors or other monitoring devices placed within this reduced space may be difficult to clean, repair, and/or access for maintenance.

In this stacked arrangement, operators may need to monitor the positions and thicknesses of the wall boards to ensure the wall boards comply with manufacturing requirements. Operators may also need to monitor the wall boards on the multilayered structure to ensure that the boards are not overlapping with one another or otherwise mispositioned or misaligned within the structure. Failure to monitor the wall boards for such issues may result in jams and subsequent delays and inefficiencies for the wall board production line.

Through applied effort, ingenuity, and innovation, Applicant has solved problems relating to detecting positions, thicknesses, and potential overlaps of wall boards by developing solutions embodied in the present disclosure, which are described in detail below.

### SUMMARY

In general, embodiments of the present disclosure provide a sensor system and/or the like.

In accordance with various embodiments of the present disclosure there is provided a sensor system including: a frame; a plurality of rails configured to be supported by the frame and removably attached to the frame; a plurality of sensors fixedly attached to the plurality of rails, wherein the plurality of sensors are configured to detect a position, thickness, length, or orientation of one or more wall boards disposed on or within the frame and to send one or more signals based on the position, thickness, length, or orientation of the one or more wall boards; and a controller in networked communication with the plurality of sensors and configured to receive and transmit the one or more signals received from the plurality of sensors.

In some embodiments, the sensor system further includes a plurality of rollers disposed within the frame and configured to support the one or more wall boards.

In some embodiments, the plurality of rollers include one or more active rollers and one or more passive rollers.

In some embodiments, the one or more wall boards include a material selected from a group consisting of gypsum and fiberglass.

In some embodiments, he plurality of rollers are disposed within the frame such that the plurality of rollers form one or more layers of vertically-aligned rollers, wherein each layer of the one or more layers of vertically-aligned rollers is configured to support the one or more wall boards.

In some embodiments, the sensor system further includes a gate in networked communication with the controller and configured to selectively open and close to permit and restrict passage, respectively, of the one or more wall boards.

In some embodiments, the gate is configured to selectively open and close to permit and restrict passage, respectively, in response to the one or more signals.

In some embodiments, one or more rails of the plurality of rails are configured to be slidably inserted and slidably removed from the frame.

In some embodiments, the sensor system further includes a plurality of wheels fixedly attached to the plurality of rails and configured to wheel the plurality of rails into and out of the frame.

In some embodiments, the sensor system further includes a plurality of mounting plates fixedly attached to the plurality of rails, wherein the plurality of sensors are fixedly attached to the plurality of mounting plates.

In some embodiments, one or more of the plurality of mounting plates are positioned on an underside of one or more of the plurality of rails.

In some embodiments, the plurality of sensors are laser sensors.

In some embodiments, the plurality of rails are stacked vertically on or within the frame such that the plurality of rails form one or more columns within the stack, and wherein the plurality of rails are disposed such that a gap exists between each of the stacked rails.

In some embodiments, the plurality of rails include a first set of rails and a second set of rails, wherein the plurality of sensors are fixedly attached to the first set of rails and to the second set of rails such that the sensors are offset when the plurality of rails are stacked vertically on or within the frame.

In some embodiments, the sensor system further includes a plurality of handles fixedly attached to the plurality of rails.

According to various embodiments, there is provided a method of using a sensor system. In some embodiments, the method includes the steps of: inserting one or more wall boards into a frame; sliding a plurality of rails into the frames, wherein a plurality of sensors are fixedly attached to the plurality of rails; and detecting, by the plurality of sensors, a position, thickness, length, or orientation of the one or more wall boards.

In an embodiment, rails can extend across the full width of one or more wall boards. In another embodiment, rails can extend across a portion of the width of one or more wall boards, for example from about 40%, 50%, 60%, 70%, 80%, 90% or greater to essentially all of the width of the wall boards. The disclosed rail configuration (with associated spaced-apart sensors) can allow detection of overlapping boards and misaligned boards. In an embodiment, a rail with spaced-apart sensors can extend across widths as described above (including full width). Such embodiments can depart from design heuristics to provide just enough space between frames to provide for walkways and routine repairs, because servicing the disclosed longer rails and spaced-apart sensors requires more space between frames. The additional space can be needed to fully retract embodiments of the disclosed rails to service the sensors.

In some embodiments, the one or more wall boards comprise two or more wall boards, and the method further includes the steps of detecting, by the plurality of sensors, an overlap between the two or more wall boards within the frame.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is diagram illustrating example architecture for an example controller in accordance with various embodiments of the present disclosure;

FIG. 2 is a schematic of an example controller for an example controller in accordance with various embodiments of the present disclosure;

FIG. 3 is a schematic of an example user computing entity for an example controller in accordance with various embodiments of the present disclosure;

FIG. 4 is an isometric view of an example wall board sensor system in accordance with various embodiments of the present disclosure;

FIG. 5A is a top plan view of an example wall board sensor system in accordance with various embodiments of the present disclosure;

FIG. 5B is a detail view of an example wall board sensor system in accordance with various embodiments of the present disclosure;

FIG. 6A is an elevation side view of an example wall board sensor system in accordance with various embodiments of the present disclosure;

FIG. 6B is a detail view of an example wall board sensor system in accordance with various embodiments of the present disclosure;

FIGS. 7A and 7B are rear elevation views of an example wall board sensor system in accordance with various embodiments of the present disclosure;

FIG. 7C is a detail view of an example wall board sensor system in accordance with various embodiments of the present disclosure;

FIG. 8 is an isometric view of an example sensor rail in accordance with various embodiments of the present disclosure;

FIG. 9 is an isometric view of an example sensor rail in accordance with various embodiments of the present disclosure;

FIGS. 10A-10C are detail views of an example sensor rail in accordance with various embodiments of the present disclosure;

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

As should be appreciated, various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure may also take the form of an entirely hardware embodiment, an entirely computer program product embodiment, and/or an embodiment that comprises combination of computer program products and hardware performing certain steps or operations.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

### Overview

Multi-sensor systems may be used to monitor and/or control wall board production, according to various embodiments. In some embodiments, wall boards (e.g., gypsum or fiberglass) may be supported by a plurality of rollers in a multi-layered frame or similar structure. In some embodiments, the plurality of rollers may be stacked vertically within the frame, creating multiple layers/levels on which storing wall boards may be stored during one phase of wall board production (e.g., just prior to entering a dryer).

In some embodiments, the frame may include a plurality of rails positioned between and/or in parallel with the layers of rollers. In some embodiments, to monitor the layers of wall boards, a plurality of sensors may be attached to the plurality of rails. In some embodiments, the plurality of rails may be interspersed between the layers of rollers and the sensors may be mounted on the rails (e.g., via a plurality of mounting plates) and oriented to face downward. In some embodiments, the sensors may be placed in offset positions on the rails such that, when the rails are stacked, the sensors do not overlap/are not aligned. In some embodiments, the plurality of sensors may then simultaneously monitor the wall boards within the frame. In some embodiments, the ability to remove the plurality of rails from the frame may assist operators in cleaning, repairing, and/or maintaining the plurality of sensors. In some embodiments, the plurality of rails may be attached to wheels and configured to be wheeled into and out of the frame by an operator, allowing the sensors to be slidably removed from the frame for cleaning, repairs, and/or maintenance.

In some embodiments, the sensors may monitor the position, thickness, length, and/or orientation of the wall boards. In some embodiments, the sensors may detect whether the wall boards are overlapped within the frame. In some embodiments, the sensors may be laser sensors.

In some embodiments, the sensors may be in networked communication with a controller and configured to send one or more signals to the controller related to the position, thickness, length, and/or orientation of the wall boards, and/or whether the wall boards are overlapped within the frame. In some embodiments, the controller may be configured to send signals received by the sensors to one or more operators as feedback. In some embodiments, the controller may be in networked communication with one or more other components of the wall board production system. For example, the frame may include a gate configured to raise and lower to permit and restrict movement of the wall boards into and out of the frame, respectively; in some embodiments, the gate may be in networked communication with the controller and configured to raise and/or lower based on one or more signals received from the sensors and sent to the controller. Continuing with the example, in some embodiments, the gate may be configured to lower and restrict passage of the wall boards when the sensors send a signal to the controller that the wall boards are overlapped.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially, such that one instruction is retrieved, loaded, and executed at a time. In some exemplary embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

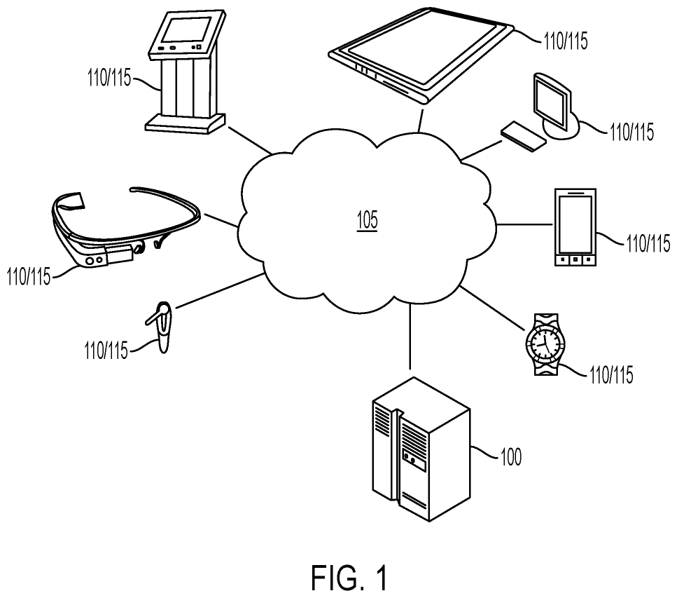

FIG. 1 provides an illustration of an exemplary system architecture that may be used in accordance with various embodiments of the present disclosure. As shown in FIG. 1, the architecture may include one or more controllers 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary Controller

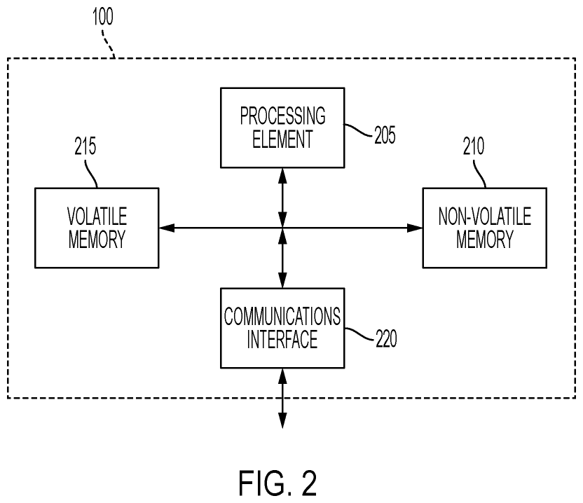

FIG. 2 provides a schematic of an example controller 100 according to one embodiment of the present disclosure. In general, the terms computing entity, computer, entity, device, system, and/or similar words used herein interchangeably may refer to, for example, one or more computers, computing entities, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the controller 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the controller 100 may communicate with user computing entities 110 and/or a variety of other computing entities.

As shown in FIG. 2, in one embodiment, the controller 100 may include or be in communication with one or more processing elements 205 (also referred to as processors, processing circuitry, and/or similar terms used herein interchangeably) that communicate with other elements within the controller 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly. For example, in some embodiments, the processing element 205 may be configured to analyze one or more images.

In one embodiment, the controller 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the controller 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the controller 100 with the assistance of the processing element 205 and operating system.

As indicated, in one embodiment, the controller 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the controller 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the controller 100 may include or be in communication with one or more input elements, such as a keyboard input, a mouse input, a touch screen/display input, motion input, movement input, audio input, pointing device input, joystick input, keypad input, and/or the like. The controller 100 may also include or be in communication with one or more output elements (not shown), such as audio output, video output, screen/display output, motion output, movement output, and/or the like.

As will be appreciated, one or more of the controller's 100 components may be located remotely from other controller 100 components, such as in a distributed system. Furthermore, one or more of the components may be combined and additional components performing functions described herein may be included in the controller 100. Thus, the controller 100 can be adapted to accommodate a variety of needs and circumstances. As will be recognized, these architectures and descriptions are provided for exemplary purposes only and are not limiting to the various embodiments.

### Exemplary User Computing Entity

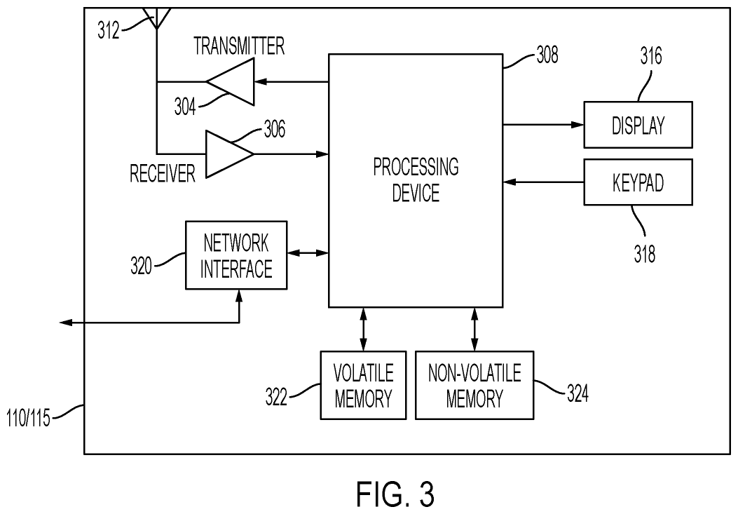

A user may be an individual, a family, a company, an organization, an entity, a department within an organization, a representative of an organization and/or person, and/or the like. To do so, a user may operate a user computing entity 110 that includes one or more components that are functionally similar to those of the controller 100. FIG. 3 provides an illustrative schematic representative of a user computing entity 110 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the controller 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the controller 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise an IETM viewer (that can include a display 316 coupled to a processing element 308) and/or a viewer (coupled to a processing element 308). For example, the IETM viewer may be a user application, browser, user interface, graphical user interface, and/or similar words used herein interchangeably executing on and/or accessible via the user computing entity 110 to interact with and/or cause display of information from the controller 100, as described herein. The term “viewer” is used generically and is not limited to “viewing.” Rather, the viewer is a multi-purpose digital data viewer capable and/or receiving input and providing output. The viewer can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the viewer can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other IETM viewer for communicating with the controller 100 and/or various other computing entities.

In another embodiment, the user computing entity 110 may include one or more components or functionality that are the same or similar to those of the controller 100, as described in greater detail above. As will be recognized, these architectures and descriptions are provided for exemplary purposes only and are not limiting to the various embodiments.

### Exemplary System Operations

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. Greater or fewer operations may be performed than shown in the figures and described herein. These operations may also be performed in a different order than those described herein.

As described above, the controller 100 and/or user computing entity 110 may be configured for storing technical documentation (e.g., data) in an IETM, providing access to the technical documentation to a user via the IETM, and/or providing functionality to the user accessing the technical documentation via the IETM. In general, the technical documentation is typically made up of volumes of text along with other media objects. In many instances, the technical documentation is arranged to provide the text and/or the media objects on an item. For instance, the item may be a product, machinery, equipment, a system, and/or the like such as, for example, a bicycle or an aircraft.

Accordingly, the technical documentation may provide textual information along with non-textual information (e.g., one or more visual representations) of the item and/or components of the item. Textual information generally includes alphanumeric information and may also include different element types such as graphical features, controls, and/or the like. Non-textual information generally includes media content such as illustrations (e.g., 2D and 3D graphics), video, audio, and/or the like. Although the non-textual information may also include alphanumeric information.

The technical documentation may be provided as digital media in any of a variety of formats, such as JPEG, JFIF, JPEG2000, EXIF, TIFF, RAW, DIV, GIF, BMP, PNG, PPM, MOV, AVI, MP4, MKV, and/or the like. In addition, the technical documentation may be provided in any of a variety of formats, such as DOCX, HTMLS, TXT, PDF, XML, SGML, JSON and/or the like. As noted, the technical documentation may provide textual and non-textual information of various components of the item. For example, various information may be provided with respect to assemblies, sub-assemblies, sub-sub-assemblies, systems, subsystems, sub-subsystems, individual parts, and/or the like associated with the item.

In various embodiments, the technical documentation for the item may be stored and/or provided in accordance with S1000D standards and/or a variety of other standards. According to various embodiments, the controller 100 and/or user computing entity 110 provides functionality in the access and use of the technical documentation provided via the IETM in accordance with user instructions and/or input received from the user via an IETM viewer (e.g., a browser, a window, an application, a graphical user interface, and/or the like).

Accordingly, in particular embodiments, the IETM viewer is accessible from a user computing entity 110 that may or may not be in communication with the controller 100. For example, a user may sign into the controller 100 from the user computing entity 110 or solely into the user computing entity 110 to access technical documentation via the IETM and the controller 100 and/or user computing entity 110 may be configured to recognize any such sign in request, verify the user has permission to access the technical documentation (e.g., by verifying the user's credentials), and present/provide the user with various displays of content for the technical documentation via the IETM viewer (e.g., displayed on display 316).

Further detail is now provided with respect to various functionality provided by embodiments of the present disclosure. As one of ordinary skill in the art will understand in light of this disclosure. The modules now discussed and configured for carrying out various functionality may be invoked, executed, and/or the like by the controller 100, the user computing entity 110, and/or a combination thereof depending on the embodiment.

### Example Sensor Systems

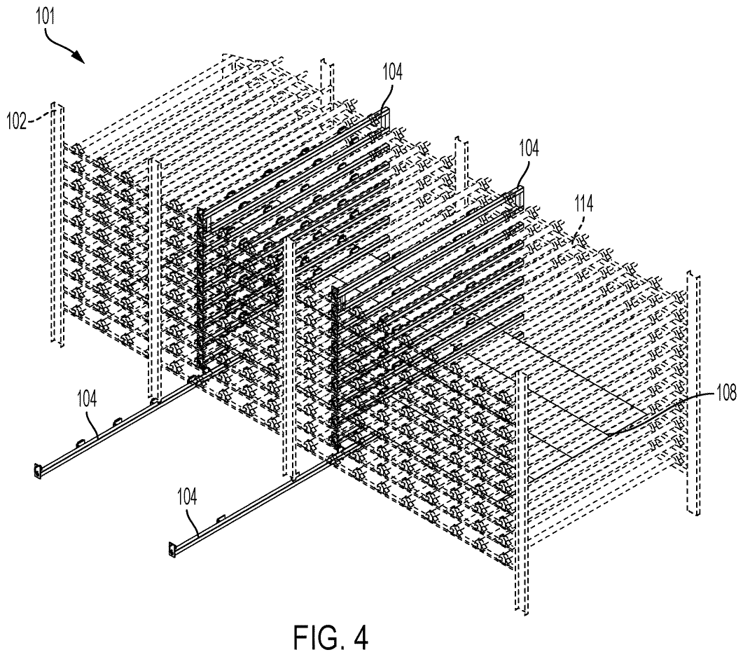

FIG. 4 shows an isometric view of an example sensor system 101, according to various embodiments. In some embodiments, the sensors system 101 may include a frame 102. In some embodiments, the frame 102 may be a substantially rigid, metal frame fixed to a surface, such as the floor of a wall board production plant. In some embodiments, the frame 102 may be part of a larger frame or superstructure within a wall board production plant. In some embodiments, the frame 102 may include low-friction frame supports such as polymer blocks, which may contain friction-reducing additives, such as PTFE, oil, carbon fiber, and/or graphite powder. In some embodiments, the frame 102 may include roller bearings and/or ball bearings.

In some embodiments, still referring to FIG. 4, the sensor system 101 may include a plurality of rails 104. In some embodiments, the plurality of rails 104 may be supported by the frame 102 and removably attached to the frame 102. In some embodiments, the plurality of rails 104 may be stacked within the frame 102, such that the plurality of rails 104 form one or more columns, as shown in the figures. In some embodiments, and as shown in at least FIG. 4, one or more rails of the plurality of rails 104 may be slidably insertable into the frame 102. For example, FIG. 4 shows the two bottom rails of the plurality of rails 104 have been slid out of the frame 102, while the remaining rails of the plurality of rails 104 are still slidably inserted into the frame 102. In some embodiments, individual rails of the plurality of rails 104 may be removed from the frame 102 without having to remove other rails of the plurality of rails 104.

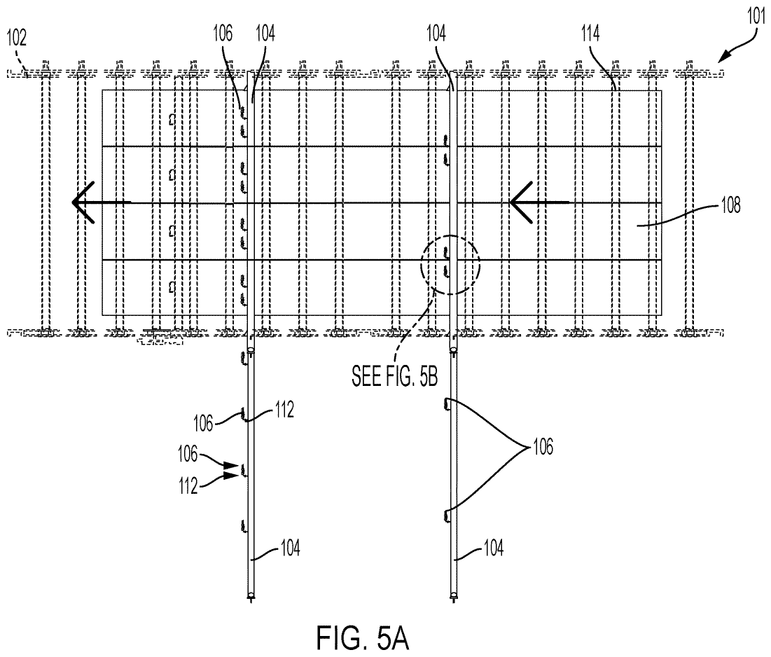

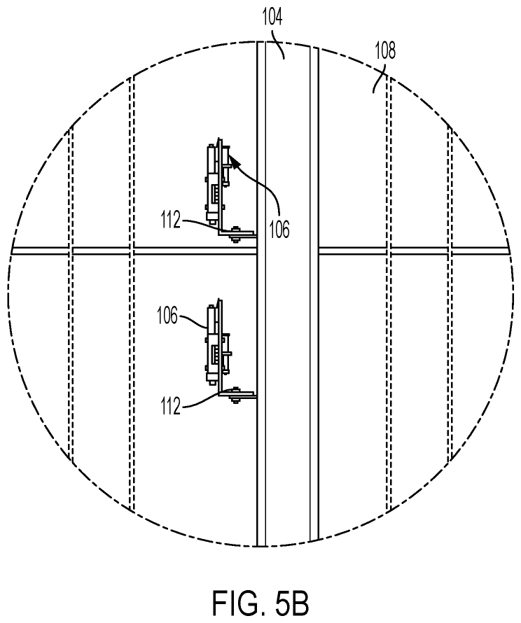

FIG. 5A shows a top plan view of an example sensor system 101, according to various embodiments. In some embodiments, the sensor system 101 may include a plurality of sensors 106 that are operably or fixedly attached to the plurality of rails 104. In some embodiments, the plurality of sensors 106 may be laser sensors configured to detect one or more of a position, thickness, length, or orientation of one or more wall boards 108 (e.g., gypsum or fiberglass boards) disposed within the frame 102.

FIG. 5B shows a detail view of two sensors from the plurality of sensors 106. The view is taken from the region indicated as “A-A” in FIG. 5A. In some embodiments, the plurality of sensors 106 may be fixedly attached to the plurality of rails 104 by a plurality of mounting plates 112. In some embodiments, the plurality of mounting plates 112 may be fixed to the plurality of rails 104 by one or more fasteners.

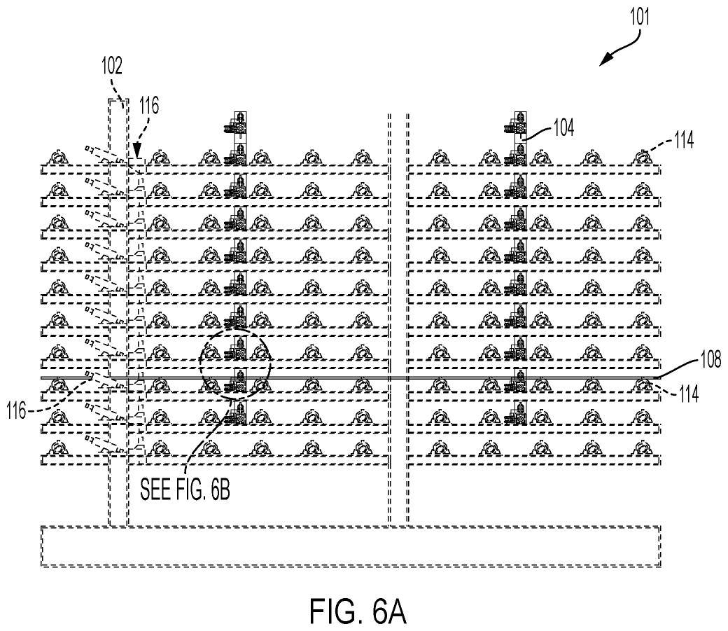

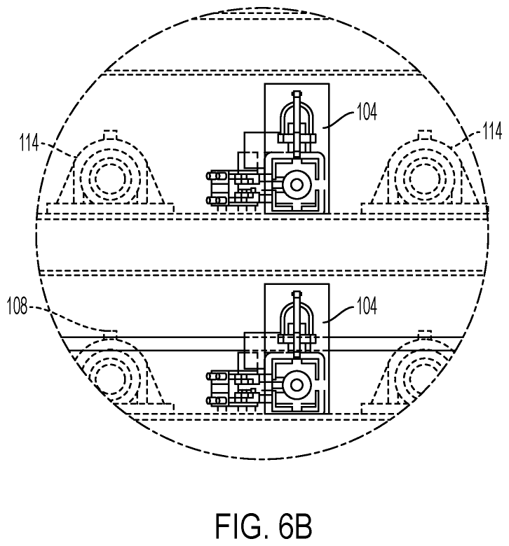

FIG. 6A shows an elevation side view of an example sensor system 101. In some embodiments, the sensor system 101 may include a plurality of rollers 114. In some embodiments, the plurality of rollers 114 may be supported by the frame 102. In some embodiments, the plurality of rollers 114 may include one or more active rollers and one or more passive rollers. In some embodiments, the one or more wall boards 108 may be supported by the plurality of rollers 114. In some embodiments, the plurality of rollers 114 may be configured to transport the one or more wall boards 108 into and out of the frame 102, and/or to other parts in the wall board production line.

In some embodiments, and as shown in at least FIG. 6A, the system 101 may include one or more gates 116 that may be configured to raise and/or lower to permit and/or restrict passage of the one or more wall boards 108. In some embodiments, the gates 116 may be in networked communication with one or more of the controller 100 as previously described and/or the plurality of sensors 106.

FIG. 6B shows a detail view of the example sensor system 101. The view is taken from the region indicated as “B-B” in FIG. 6A. In some embodiments, there may be a gap between one or more rails of the plurality of rails 104. In some embodiments, the gap may range between 8 inches and 12 inches. In some embodiments, the gap may be smaller or larger, and the gap between individual rollers and rails of the plurality of rollers 114 and the plurality of rails 104 may be homogeneous (i.e., the gaps are equal throughout), while in other embodiments the gap may be heterogeneous. In some embodiments, the plurality of rails 104 may be interspersed between the plurality of rollers 114.

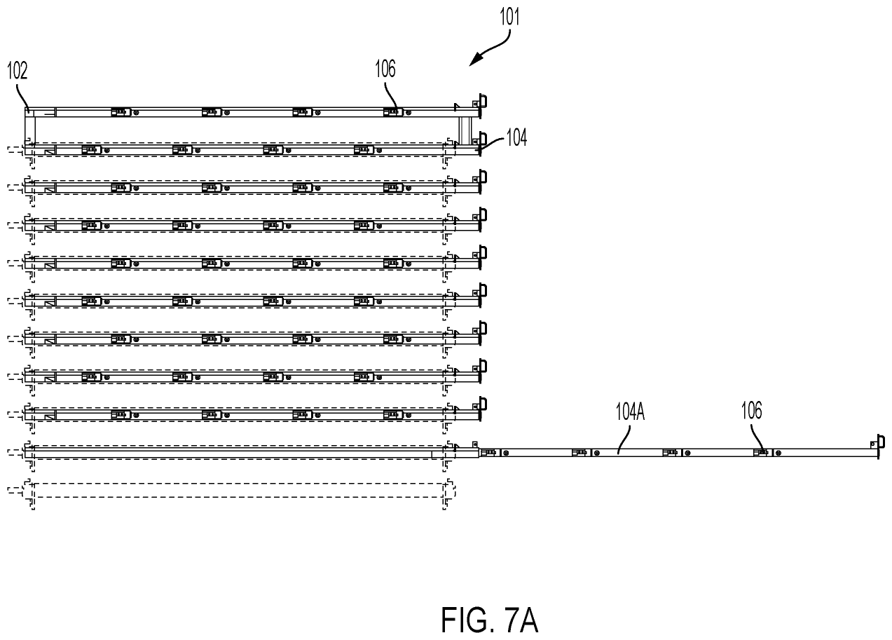

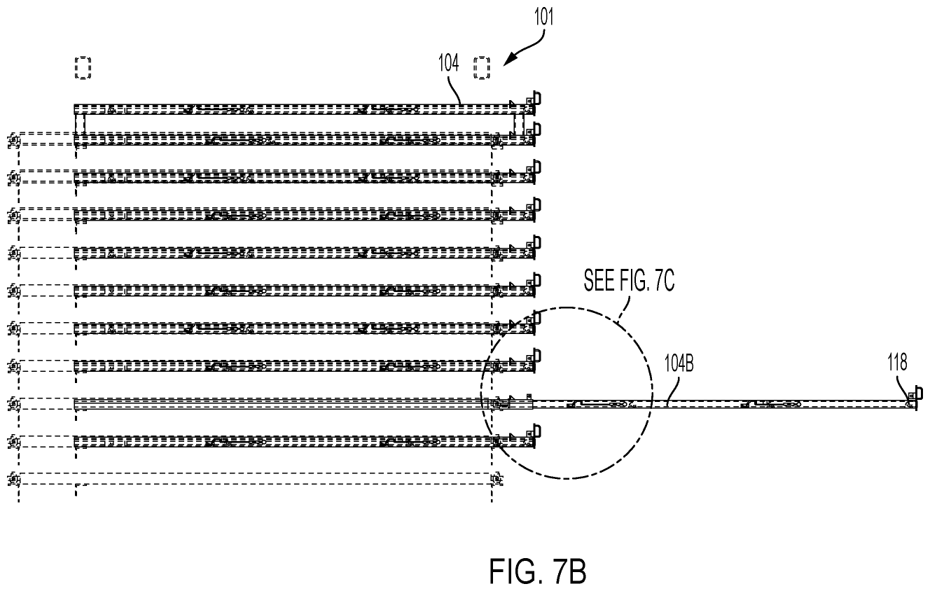

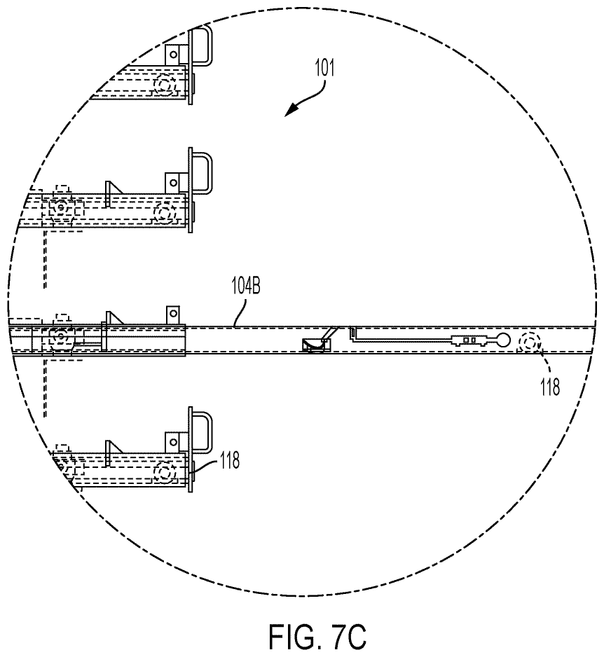

FIGS. 7A and 7B show rear elevation views of the example sensor system 101, and FIG. 7C shows a detail view of the example sensor system 101. The view is taken from the region indicated as C-C in FIG. 7B. In some embodiments, and as previously mentioned, one or more rails of the plurality of rails 104 may be slidably removable from the frame 102. An individual rail 104A of the plurality of rails 104 that has been slid out of the frame 102 is shown in at least FIGS. 7A-7C. In at least this way, the plurality of sensors 106 may be cleaned and or undergo maintenance when removed from the frame 102. In some embodiments, and as shown in at least FIGS. 7B and 7C, one or more rails 104B of the plurality of rails 104 may be fixedly attached to one or more wheels 118. In some embodiments, the one or more wheels 118 may be used to facilitate the removal of the plurality of rails 104 from the frame 102. In some embodiments, the wheels 118 may be used to reduce the friction generated when the rails 104 are removed from the frame 102.

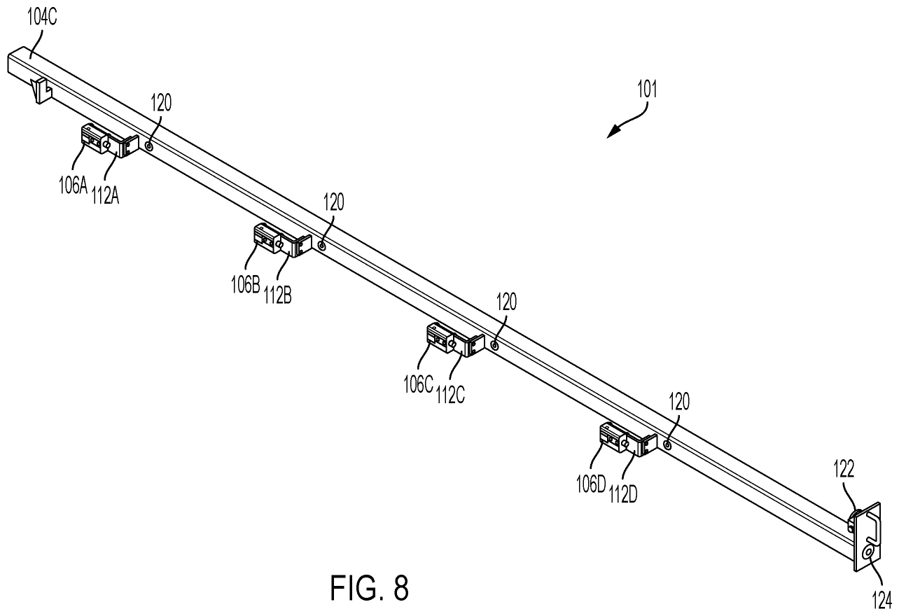

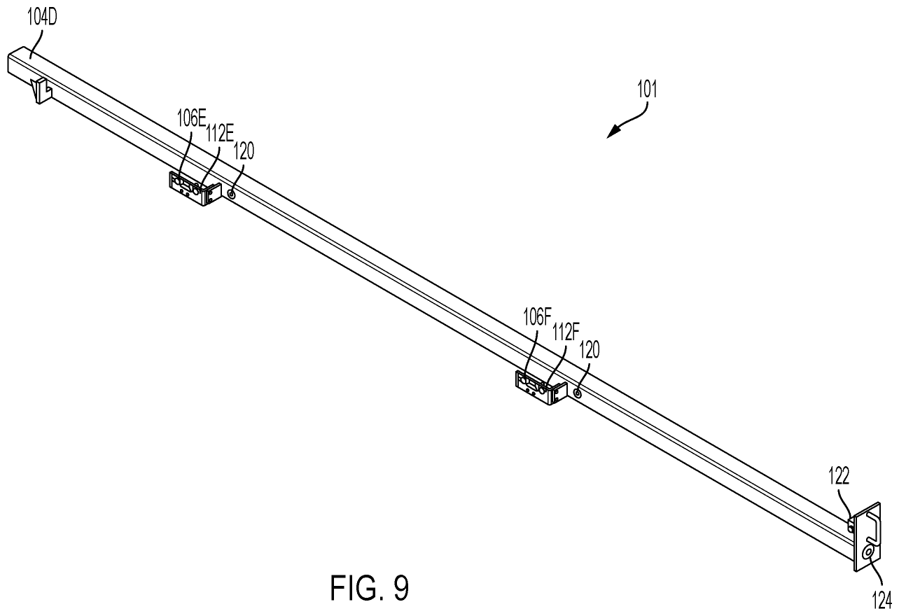

FIGS. 8 and 9 are isometric views of example rails 104C and 104D, respectively, from the plurality of rails 104. The description of the example rails 104C, 104D, and 104E and their various components may be understood in some embodiments as applying to various rails of the plurality of rails 104, according to various embodiments.

As shown in FIG. 8, an example rail 104C may include one or more grommets 120 or similar component for covering one or more holes providing access to the interior of the rail 104C. In some embodiments, one or more wires or other electronics may be disposed within the rail 104C. As previously mentioned, the system 101 may include a plurality of mounting plates 112 that may be fixedly attached to the plurality of rails. As shown in at least FIG. 8, four mounting plates 112A-D are fixedly attached to the example rail 104C. Also as shown in at least FIG. 8, four sensors 106A-D are fixedly attached to the respective mounting plates 112A-D. In some embodiments, wiring for the sensors 106A-D may be disposed within the example rail 104C. In some embodiments, the example rail 104C may be secured to the frame by a fastener 122, such as a pin. In some embodiments, the example rail 104C may include a handle 124 configured to be gripped by a user to pull the example rail 104C from the frame 102.

FIG. 9 shows an isomeric view of an example rail 104D that is offset from the example rail 104C shown in FIG. 8. That is, the sensors 106A-D and the mounting plates 112A-D of the example rail 104C are not aligned with the sensors 106E and 106F and the mounting plates 112E and 112F of the example rail 104D. In some embodiments, the plurality of rails 104 may be arranged in the frame 102 such that rails of the type like example rail 104C are stacked on top of or below rails of the type like example rail 104D, such that the plurality of sensors 106 and the plurality of mounting plates 112 for the sensor system 101 are not aligned/are offset.

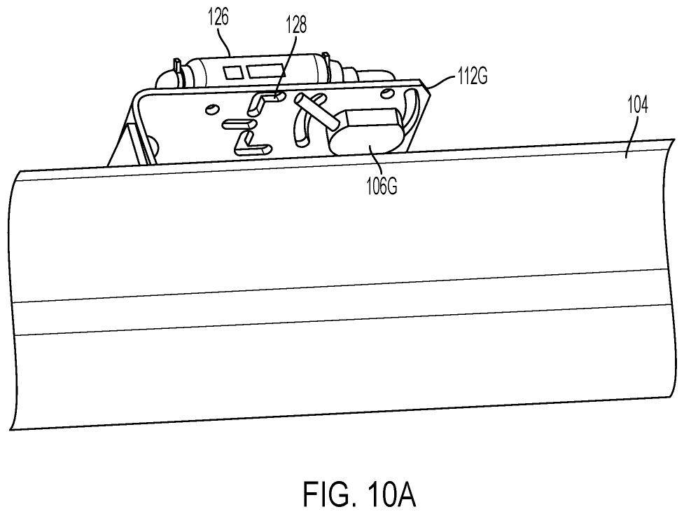

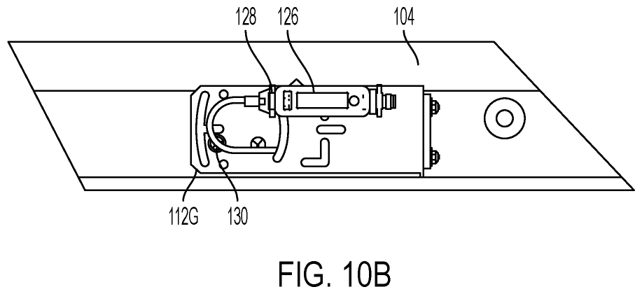

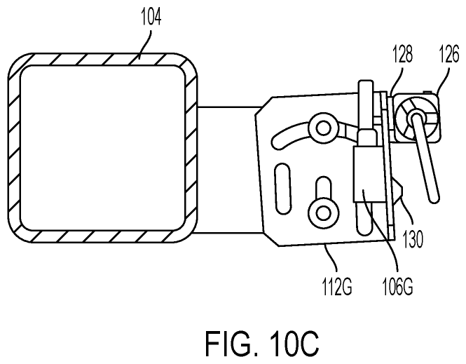

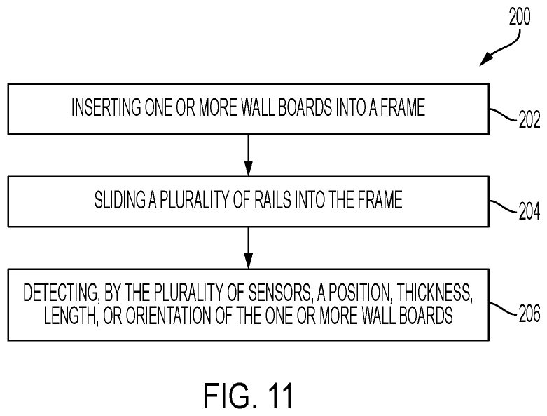

FIGS. 10A-10C show detail views of an example sensor 106G of the plurality of sensors 106. In some embodiments, one or more of the plurality of sensors 106 may be a laser sensor. In some embodiments, one or more of the plurality of sensors 106 may be a Keyence LR-X series sensor. The description of the example sensor 106G and its various components may be understood in some embodiments as applying to various rails of the plurality of sensors 106, according to various embodiments.

In some embodiments, and as shown in at least FIGS. 10C-10C, the example sensor 106G may include one or more amplifiers 126 configured to convert characteristics from the environment of the system 101 (e.g., the position of one or more wall boards 108). In some embodiments, the example sensor 106G may be fixedly attached to a mounting plate 112G, as previously described. In some embodiments, the example sensor 106G may include a mounting device 128 to which the amplifier 126 may be mounted. In some embodiments, the mounting plate 112G and/or the mounting device 128 may be attached vial one of more fasteners 130, such as screws.

### Example Methods of Use for Example Sensor Systems

FIG. 8 shows an example flow diagram illustrating an example method 200 of use for an example sensor system. In some embodiments, the example method 200 may be performed in reference to the apparatuses, systems, and devices previously described in this disclosure. However, it will be understood that the method 200 may be performed with any suitable system as desired. It will further be understood that the steps of the method 200 may be performed simultaneously or in sequence, as desired.

In some embodiments, the method 200 may include a step 202 of inserting one or more wall boards into a frame. In some embodiments, the method 200 may include a step 202 of sliding a plurality of rails into the frame. In some embodiments, the sliding may be facilitated by a plurality of wheels affixed to the plurality of rails. In some embodiments, the method 200 may include a step 206 of detecting, by the plurality of sensors, a position, thickness, length, or orientation of the one or more wall boards. In some embodiments, the method may include inserting two or more wall boards into the frame and include an additional step of detecting, by the plurality of sensors, whether there is any overlap between the two or more wall boards inserted into the frame.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A sensor system comprising:
a frame;
a plurality of rails configured to be supported by the frame and removably attached to the frame;
a plurality of sensors fixedly attached to the plurality of rails,
wherein the plurality of sensors are configured to detect a position, thickness, length, or orientation of one or more wall boards disposed on or within the frame and to send one or more signals based on the position, thickness, length, or orientation of the one or more wall boards; and
a controller in networked communication with the plurality of sensors and configured to receive and transmit the one or more signals received from the plurality of sensors.

2. The sensor system of claim 1, further comprising a plurality of rollers disposed within the frame and configured to support the one or more wall boards.

3. The sensor system of claim 2, wherein the plurality of rollers comprise one or more active rollers and one or more passive rollers.

4. The sensor system of claim 2, wherein the plurality of rollers are disposed within the frame such that the plurality of rollers form one or more layers of vertically-aligned rollers, wherein each layer of the one or more layers of vertically-aligned rollers is configured to support the one or more wall boards.

5. The sensor system of claim 1, wherein the one or more wall boards comprise a material selected from a group consisting of gypsum and fiberglass.

6. The sensor system of claim 1, further comprising a gate in networked communication with the controller and configured to selectively open and close to permit and restrict passage, respectively, of the one or more wall boards.

7. The sensor system of claim 6, wherein the gate is configured to selectively open and close to permit and restrict passage, respectively, in response to the one or more signals.

8. The sensor system of claim 1, wherein one or more rails of the plurality of rails are configured to be slidably inserted and slidably removed from the frame.

9. The sensor system of claim 1, further comprising a plurality of wheels fixedly attached to the plurality of rails and configured to wheel the plurality of rails into and out of the frame.

10. The sensor system of claim 1, further comprising a plurality of mounting plates fixedly attached to the plurality of rails, wherein the plurality of sensors are fixedly attached to the plurality of mounting plates.

11. The sensor system of claim 10, wherein one or more of the plurality of mounting plates are positioned on an underside of one or more of the plurality of rails.

12. The sensor system of claim 1, wherein the plurality of sensors comprise laser sensors.

13. The sensor system of claim 1, wherein the plurality of rails are stacked vertically on or within the frame such that the plurality of rails form one or more columns within the stack, and wherein the plurality of rails are disposed such that a gap exists between each of the stacked rails.

14. The sensor system of claim 13, wherein the plurality of rails comprises a first set of rails and a second set of rails, wherein the plurality of sensors are fixedly attached to the first set of rails and to the second set of rails such that the sensors are offset when the plurality of rails are stacked vertically on or within the frame.

15. The sensor system of claim 1, further comprising a plurality of handles fixedly attached to the plurality of rails.

16. A method of using a sensor system, the method comprising:
inserting one or more wall boards into a frame;
sliding a plurality of rails into the frames,
wherein a plurality of sensors are fixedly attached to the plurality of rails; and
detecting, by the plurality of sensors, a position, thickness, length, or orientation of the one or more wall boards.

17. The method of claim 16, wherein the one or more wall boards comprise two or more wall boards, and wherein the method further comprising detecting, by the plurality of sensors, an overlap between the two or more wall boards within the frame.
